(19) United States
(12) Patent Application Publication
(10) Pub. No.: US 2009/0142483 A1
(43) Pub. Date: Jun. 4, 2009

(54) Process of Making Electrolessly Plated Auto-Calibration Circuits for Test Sensors

(76) Inventor: Andrew J. Edelbrock, Granger, IN (US)

Correspondence Address: NIXON PEABODY LLP, 161 N. CLARK STREET, 48TH FLOOR, CHICAGO, IL, 60601, US

(21) Appl. No.: 12/086,281

(22) PCT Filed: Dec. 21, 2006
(86) PCT No.: PCT/US2006/048878

§ 371 Date: Jun. 9, 2008

Related U.S. Application Data
(60) Provisional application No. 60/754,145, filed on Dec. 27, 2005.

(51) Int. Cl. B05D 5/12

(52) U.S. Cl. 427/125; 427/123

(57) ABSTRACT

A method of forming an auto-calibration circuit to be used with a sensor package. The sensor package includes at least one test sensor and is adapted to be used with an instrument or meter. A substrate is provided. Catalytic ink or catalytic polymeric solution is applied to at least one side of the substrate to assist in defining electrical connections on the substrate. The substrate is electrolessly plated with the catalytic ink or catalytic polymeric solution to form the electrical connections of the substrate. The electrical connections convey auto-calibration information for the at least one test sensor to the instrument.

### FIELD OF THE INVENTION

The present invention generally relates to a process of making auto-calibration circuits for test sensors. More specifically, the process is directed to making electroless auto-calibration circuits for test sensors that are adapted to be used in calibrating instruments or meters that determine the concentration of an analyte (e.g., glucose) in a fluid.

### BACKGROUND OF THE INVENTION

The quantitative determination of analytes in body fluids is of great importance in the diagnoses and maintenance of certain physiological abnormalities. For example, lactate, cholesterol and bilirubin should be monitored in certain individuals. In particular, it is important that diabetic individuals frequently check the glucose level in their body fluids to regulate the glucose intake in their diets. The results of such tests can be used to determine what, if any, insulin or other medication needs to be administered. In one type of blood-glucose testing system, sensors are used to test a sample of blood.

A test sensor contains biosensing or reagent material that reacts with blood glucose. The testing end of the sensor is adapted to be placed into the fluid being tested, for example, blood that has accumulated on a person's finger after the finger has been pricked. The fluid is drawn into a capillary channel that extends in the sensor from the testing end to the reagent material by capillary action so that a sufficient amount of fluid to be tested is drawn into the sensor. The fluid then chemically reacts with the reagent material in the sensor resulting in an electrical signal indicative of the glucose level in the fluid being tested. This signal is supplied to the meter via contact areas located near the rear or contact end of the sensor and becomes the measured output.

Diagnostic systems, such as blood-glucose testing systems, typically calculate the actual glucose value based on a measured output and the known reactivity of the reagent-sensing element (test sensor) used to perform the test. The reactivity or lot-calibration information of the test-sensor may be given to the user in several forms including a number or character that they enter into the instrument. One prior art method included using an element that is similar to a test sensor, but which was capable of being recognized as a calibration element by the instrument. The test element's information is read by the instrument or a memory element that is plugged into the instrument's microprocessor board for directly reading the test element.

These methods suffer from the disadvantage of relying on the user to enter the calibration information, which some users may not do. In this event, the test sensor may use the wrong calibration information and thus return an erroneous result. Improved systems use an auto-calibration circuit that is associated with the sensor package. The auto-calibration circuit is read automatically when the sensor package is placed in the meter and requires no user intervention.

One method of currently forming a metallic auto-calibration circuit is by laminating a substrate with a metal foil followed by a subtractive etching process to define the electrical connections. This process tends to be more costly than necessary because a portion of the metallic material is removed from the substrate and, thus, is not present in finalized auto-calibration circuit.

It would be desirable to provide a method for forming an auto-calibration circuit that is more cost-effective than existing processes, while still being an efficient process.

### SUMMARY OF THE INVENTION

According to one method, an auto-calibration circuit to be used with a sensor package is formed. The sensor package includes at least one test sensor and is adapted to be used with an instrument or meter. A substrate is provided. Catalytic ink or catalytic polymeric solution is applied to at least one side of the substrate. The catalytic ink or catalytic polymeric solution is used to assist in defining the electrical connections on the substrate. The substrate is electrolessly plated where the catalytic ink or catalytic polymeric solution was applied to form the electrical connections of the substrate. The electrical connections convey auto-calibration information for the at least one test sensor to the instrument.

According to another method, an auto-calibration circuit to be used with a sensor package is formed. The sensor package includes at least one test sensor and is adapted to be used with an instrument or meter. A substrate is provided. At least one aperture is formed through the substrate. Catalytic ink or catalytic polymeric solution is applied to two opposing sides of the substrate. The catalytic ink or catalytic polymeric solution is used to assist in defining the electrical connections on the substrate. The substrate is electrolessly plated where the catalytic ink or catalytic polymeric solution was applied to form the electrical connections of the substrate. The electrical connections convey auto-calibration information for the at least one test sensor to the instrument.

According to a further method, a sensor package is formed that is adapted to be used with at least one instrument in determining an analyte concentration in a fluid sample. A substrate is provided. Catalytic ink or catalytic polymeric solution is applied to at least one side of the substrate. The catalytic ink or catalytic polymeric solution is used to assist in defining the electrical connections on the substrate. The substrate is electrolessly plated where the catalytic ink or catalytic polymeric solution was applied to form the electrical connections of the substrate. The electrical connections convey auto-calibration information for the at least one test sensor to the instrument. The auto-calibration circuit is attached to a surface of a sensor-package base. At least one test sensor is adapted to receive the fluid sample and is operable with at least one instrument is provided.

### BRIEF DESCRIPTION OF THE DRAWINGS

FIG. 1 is a top perspective view of a sensing instrument according to one embodiment.

FIG. 2 is the top perspective view of an interior of the sensing instrument of FIG. 1.

FIG. 3 is a sensor package according to one embodiment for use with the sensing instrument of FIGS. 1 and 2.

FIG. 4 is a top view of an auto-calibration circuit or label formed by one method of the present invention.

FIG. 5 is a top view of the auto-calibration circuit of FIG. 4 according to one pattern.

FIG. 6 is a top view of an auto-calibration circuit formed by another method of the present invention.

FIG. 7 is a top view of an auto-calibration circuit of FIG. 6 according to one pattern.

FIG. 8a is a top perspective view of a substrate that is used to form the auto-calibration circuit of FIG. 4 according to one process.

FIG. 8b is the substrate of FIG. 8a with catalytic ink or catalytic polymeric solution being added thereto according to one process.

FIG. 8c is the substrate with the catalytic ink or catalytic polymeric solution of FIG. 8b being exposed to ultraviolet light.

FIG. 8d is a side view of a bath that is adapted to electrolessly plate the substrate with an electroless plated solution after being exposed to the ultraviolet light of FIG. 8c.

FIG. 9a is a top perspective view of a substrate that is used to form an auto-calibration circuit according to another process.

FIG. 9b is the substrate of FIG. 9a with a plurality of apertures formed therein.

FIG. 9c is a top perspective view of the substrate of FIG. 9b with catalytic ink or catalytic polymeric solution being added thereto.

FIG. 9d is a bottom perspective view of the substrate of FIG. 9b with catalytic ink or catalytic polymeric solution being added thereto.

FIG. 9e is a top perspective view of the substrate with the catalytic ink or catalytic polymeric solution of FIGS. 9c, 9d being exposed to ultraviolet light.

FIG. 9f is a bath that is adapted to electrolessly plate the substrate with an electroless plated solution after being exposed to ultraviolet light of FIG. 9e.

FIG. 10a is an enlarged side view of an aperture depicted in FIG. 9b after catalytic ink or catalytic polymeric solution has been applied to the substrate.

FIG. 10b is an enlarged side view of the aperture depicted in FIG. 10a after the substrate has been electrolessly plated.

### DETAILED DESCRIPTION OF ILLUSTRATED EMBODIMENTS

An instrument or meter in one embodiment uses a test sensor adapted to receive a fluid sample to be analyzed, and a processor adapted to perform a predefined test sequence for measuring a predefined parameter value. A memory is coupled to the processor for storing predefined parameter data values. Calibration information associated with the test sensor may be read by the processor before the fluid sample to be measured is received. Calibration information may be read by the processor after the fluid sample to be measured is received, but not after the concentration of the analyte has been determined. Calibration information is used in measuring the predefined parameter data value to compensate for different characteristics of test sensors, which will vary on a batch-to-batch basis. Variations of this process will be apparent to those of ordinary skill in the art from the teachings disclosed herein, including but not limited to, the drawings.

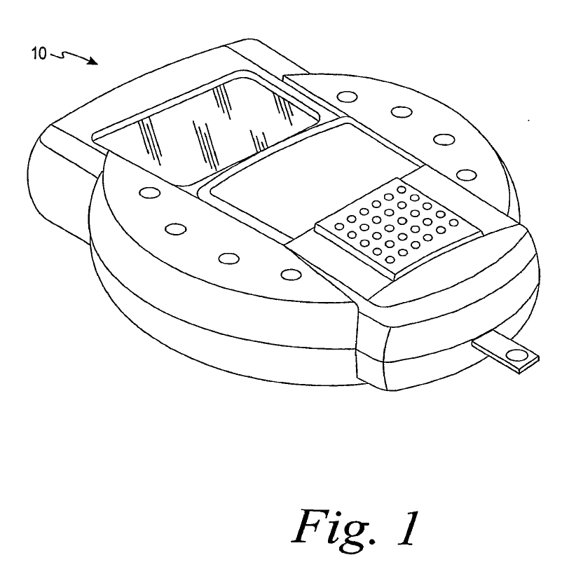

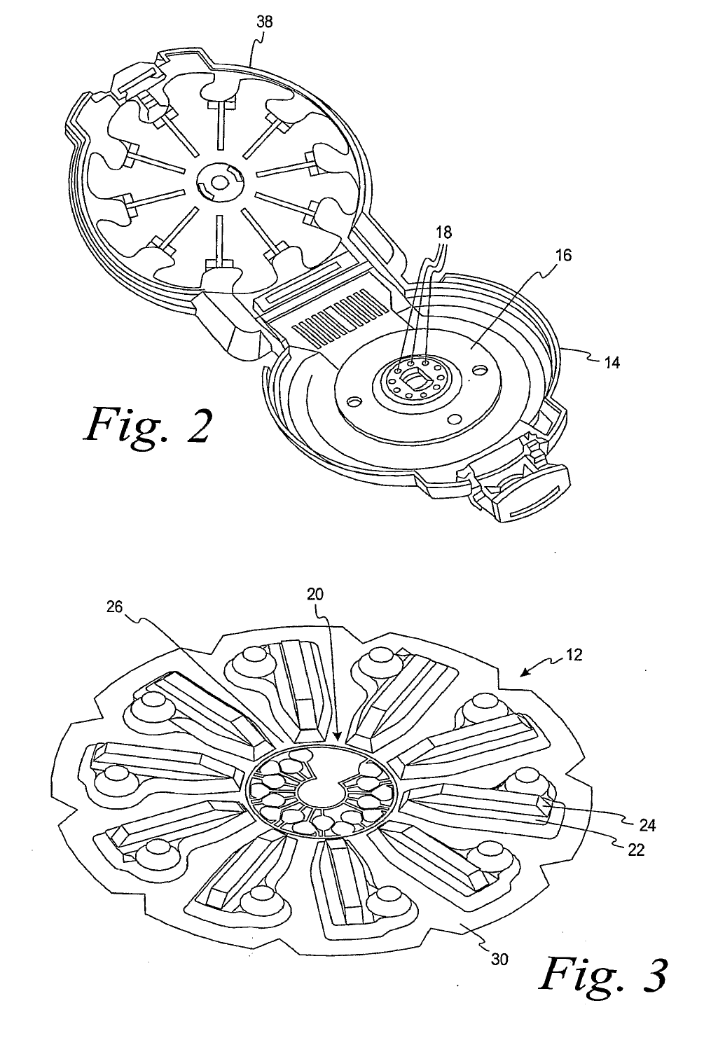

Referring now to FIGS. 1-3, an instrument or meter 10 is illustrated. In FIG. 2, the inside of the instrument 10 is shown in the absence of a sensor package. One example of a sensor package (sensor package 12) is separately illustrated in FIG. 3. Referring back to FIG. 2, a base member 14 of the instrument 10 supports an auto-calibration plate 16 and a predetermined number of auto-calibration pins 18. As shown in FIG. 2, for example, the instrument 10 includes ten auto-calibration pins 18. It is contemplated that the number of auto-calibration pins may vary in number and shape from that shown in FIG. 2. The auto-calibration pins 18 are connected for engagement with the sensor package 12.

The sensor package 12 of FIG. 3 includes an auto-calibration circuit or label 20, a plurality of test sensors 22, and a sensor-package base 26. The plurality of test sensors 22 is used to determine concentrations of analytes. Analytes that may be measured include glucose, lipid profiles (e.g., cholesterol, triglycerides, LDL and HDL), microalbumin, hemoglobin A_{1C}, fructose, lactate, or bilirubin. It is contemplated that other analyte concentrations may be determined. The analytes may be in, for example, a whole blood sample, a blood serum sample, a blood plasma sample, other body fluids like ISF (interstitial fluid) and urine, and non-body fluids. As used within this application, the term “concentration” refers to an analyte concentration, activity (e.g., enzymes and electrolytes), titers (e.g., antibodies), or any other measure concentration used to measure the desired analyte.

In one embodiment, the plurality of test sensors 22 includes an appropriately selected enzyme to react with the desired analyte or analytes to be tested. An enzyme that may be used to react with glucose is glucose oxidase. It is contemplated that other enzymes may be used such as glucose dehydrogenase. An example of a test sensor is disclosed in U.S. Pat. No. 6,531,040 assigned to Bayer Corporation. It is contemplated that other test sensors may be used.

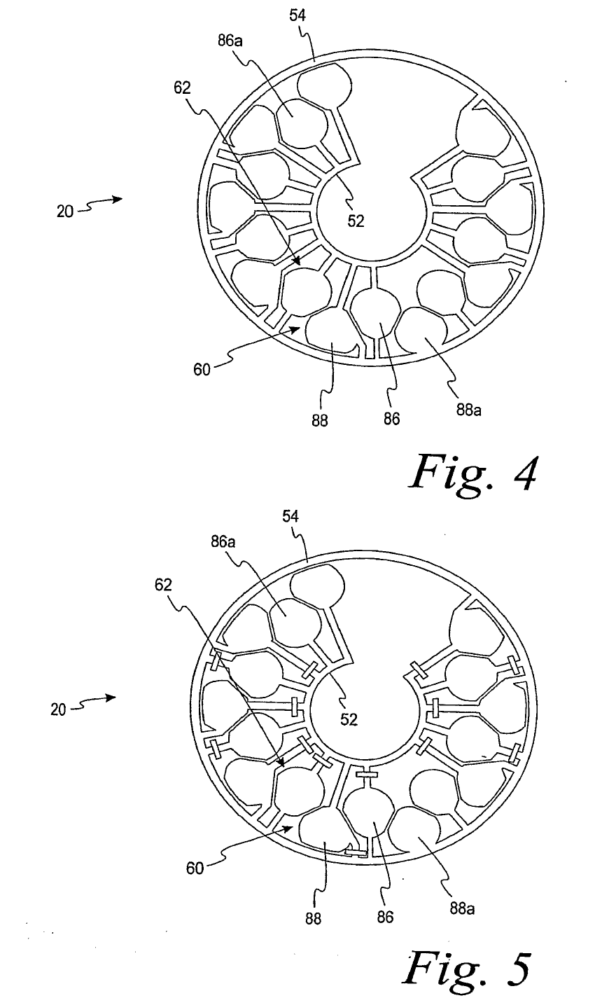

Calibration information or codes assigned for use in the clinical value computations to compensate for manufacturing variations between sensor lots are encoded on the auto-calibration circuit 20. The auto-calibration circuit 20 is used to automate the process of transferring calibration information (e.g., the lot specific reagent calibration information for the plurality of test sensors 22) such that the sensors 22 may be used with at least one instrument or meter. In one embodiment, the auto-calibration circuit 20 is adapted to be used with different instruments or meters. The auto-calibration pins 18 electrically couple with the auto-calibration circuit 20 when a cover 38 of the instrument 10 is closed and the circuit 20 is present. The auto-calibration circuit 20 will be discussed in detail in connection with FIG. 4.

According to one method, an analyte concentration of a fluid sample is determined using electrical current readings and at least one equation. In this method, equation constants are identified using the calibration information or codes from the auto-calibration circuit 20. These constants may be identified by (a) using an algorithm to calculate the equation constants or (b) retrieving the equation constants from a lookup table for a particular predefined calibration code that is read from the auto-calibration circuit 20. The auto-calibration circuit 20 may be implemented by digital or analog techniques. In a digital implementation, the instrument assists in determining whether there is conductance along selected locations to determine the calibration information. In an analog implementation, the instrument assists in measuring the resistance along selected locations to determine the calibration information.

Referring back to FIG. 3, the plurality of test sensors 22 is arranged around the auto-calibration circuit 20 and extends radially from the area containing the circuit 20. The plurality of sensors 22 of FIG. 3 is stored in individual cavities or blisters 24 and read by associated sensor electronic circuitry before one of the plurality of test sensors 22 is used. The plurality of sensor cavities or blisters 24 extends toward a peripheral edge of the sensor package 12. In this embodiment, each sensor cavity 24 accommodates one of the plurality of test sensors 22.

The sensor package 12 of FIG. 3 is generally circular in shape with the sensor cavities 24 extending from near the outer peripheral edge toward and spaced apart from the center of the sensor package 12. It is contemplated, however, that the sensor package may be of different shapes then depicted in FIG. 3. For example, the sensor package may be a square, rectangle, other polygonal shapes, or non-polygonal shapes including oval.

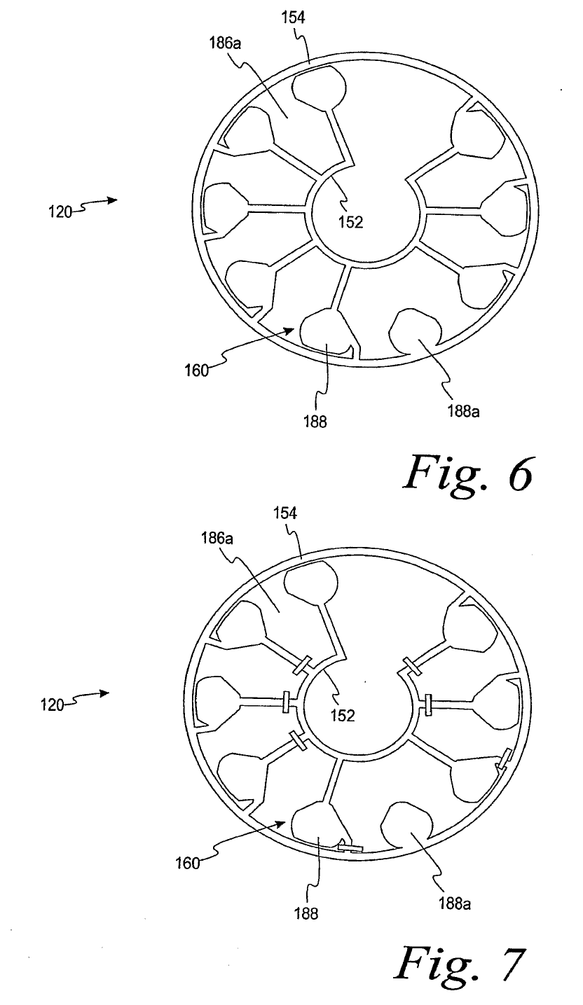

With reference to FIG. 4, the auto-calibration circuit 20 in this embodiment is adapted to be used with (a) the instrument or meter 10, (b) a second instrument or meter (not shown) being distinct or different from the instrument 10, and (c) the plurality of sensors 22 operable with both the instrument 10 and the second instrument. Thus, in this embodiment, the auto-calibration circuit 20 may be considered as “backwards” compatible because it is adapted to be used with the second instrument (i.e., a new instrument) and the first instrument (i.e., an older instrument). The auto-calibration circuit may be used to work with two older instruments or two newer instruments. To reduce or avoid manufacturing modifications, it is desirable for a “backwards” compatible auto-calibration circuit not to increase the size of the circuit or decrease the size of the electrical contact areas. In another embodiment that will be discussed below in connection with FIGS. 6 and 7, an auto-calibration circuit is adapted to be used with one instrument.

According to one embodiment, the sensor package contains a plurality of sensors operable with at least one instrument (e.g., sensor package 12 containing a plurality of sensors 22 operable with the instrument 10 and the second instrument). When the plurality of sensors 22 has essentially the same calibration characteristics, calibrating the instrument 10 for one of the sensors 22 is effective to calibrate the instrument 10 for each of the plurality of sensors 22 in that particular package 12.

The auto-calibration circuit 20 of FIG. 4 includes an inner ring 52, an outer ring 54, a plurality of electrical connections 60, and a plurality of electrical connections 62 distinct from the plurality of electrical connections 60. For some applications, the inner ring 52 represents logical 0s and the outer ring 54 represents logical 1s. It is contemplated that the inner ring or the outer ring may not be continuous. For example, the inner ring 52 is not continuous because it does not extend to form a complete circle. The outer ring 54, on the other hand, is continuous. The inner ring and the outer ring may both be continuous and in another embodiment the inner ring and the outer ring are not continuous. It is contemplated that the inner ring and outer rings may be shapes other than circular. Thus, the term “ring” as used herein includes non-continuous structures and shapes other than circular.

The plurality of electrical connections 60 includes a plurality of outer contact areas 88 (e.g., contact pads). The plurality of outer contact areas 88 is radially positioned around the circumference of the auto-calibration circuit 20. The plurality of electrical connections 62 includes a plurality of inner contact areas 86. The inner contact areas 86 are positioned closed to the center of the circuit 20 than the outer contact areas 88. It is contemplated that the plurality of outer contact areas and the inner contact areas may be located in different positions than depicted in FIG. 4.

The plurality of electrical connections 62 is distinct from the plurality of electrical connections 60. It will be understood, however, that use of the term “distinct” in this context may only mean that the encoded information is distinct, but the decoded information is essentially the same. For example, the instrument 10 may have essentially the same calibration characteristics, but the contacts, e.g., pins 18, to couple with the encoded-calibration information are located in different places for each instrument. Accordingly, the encoded-calibration information of the first and second instruments corresponding to each instrument is distinct because the encoded information must be arranged to couple with the appropriate instrument.

In the embodiment depicted in FIG. 4, the plurality of electrical connections 60 is adapted to be routed directly from each of the plurality of outer contact areas 88 to a respective first common connection (e.g., inner ring 52) or a second common connection (e.g., outer ring 54). Thus, the electrical connections of the plurality of outer contact areas 88 are not routed through any of the inner contact areas 86. By having such an arrangement, additional independent encoded-calibration information may be obtained using the same total number of inner and outer contact areas 86, 88 without increasing the size of the auto-calibration circuit 20. Additionally, potential undesirable electrical connections may occur if the electrical connections of outer contact areas (e.g., outer pads) are routed through inner contact areas (e.g., inner pads). It is contemplated in another embodiment, however, that the outer contact areas may be routed through inner contact areas.

The plurality of electrical connections 60 is adapted to be utilized by the first instrument to auto-calibrate. The plurality of electrical connections 62, on the other band, is adapted to be utilized by the second instrument to auto-calibrate. Thus, the positioning of the outer contact areas 88 and the inner contact areas 86 permits the auto-calibration circuit 20 to be read by instruments or meters that are capable of contacting either the plurality of outer contact areas 88 or the plurality of inner contact areas 86.

The information from the plurality of electrical connections 60 corresponds to the plurality of test sensors 22. The information obtained from the plurality of electrical connections 62 also corresponds to the plurality of test sensors 22.

According to one embodiment, substantially all of the plurality of outer contact areas 88 are initially electrically connected to the first common connection (e.g., inner ring 52) and the second common connection (e.g., outer ring 54). To program the auto-calibration circuit, substantially all of the outer contact areas 88 in this embodiment will only be connected to one of the inner or outer rings 52, 54. Similarly, substantially all of the plurality of inner contact areas 86 are initially electrically connected to the first common connection (e.g., inner ring 52) and the second common connection (e.g., outer ring 54). To program the auto-calibration circuit, substantially all of the inner contact areas 86 in this embodiment will only be connected to one of the inner or outer rings 52, 54.

FIG. 4 does not depict a specific pattern, but rather shows a number of the potential connections of the plurality of outer and inner contact areas to the first and second common connections. One example of a pattern of the auto-calibration circuit 20 is shown in FIG. 5. It is contemplated that other patterns of the auto-calibration circuit may be formed.

Typically, at least one of the outer contact areas 88 and the inner contact area 86 will always be electrically connected to the first common connection (e.g., inner ring 52) and the second common connection (e.g., outer ring 54). For example, as shown in FIGS. 4 and 5, outer contact area 88a is always electrically connected to the outer ring 54. Similarly, inner contact area 86a is always electrically connected to the inner ring 52. By having individual outer contact areas 88 and the inner contact areas 86 only connected to the inner or outer ring 52, 54 assists in maintaining a reliable instrument since any “no connect” may be sensed by the instrument software. Thus, a defective auto-calibration circuit or bad connection from the instrument may be automatically sensed by the instrument software.

The instrument may include several responses to reading the auto-calibration circuit. For example, responses may be include the following codes: (1) correct read, (2) misread, (3) non-read, defective code, (4) non-read, missing circuit, and (5) read code out-of-bounds. A correct read indicates that the instrument or meter correctly read the calibration information. A misread indicates that the instrument did not correctly read the calibration information encoded in the circuit. In a misread, the circuit passed the integrity checks. A non-read, defective code indicates that the instrument senses that a circuit is present (continuity between two or more auto-calibration pins), but the circuit code fails one or more encoding rules (circuit integrity checks). A non-read, missing circuit indicates that the instrument does not sense the presence of a circuit (no continuity between any of the auto-calibration pins). A read code out-of-bounds indicates that the instrument senses an auto-calibration code, but the calibration information is not valid for that instrument.

According to another embodiment, the auto-calibration circuit may be used with one instrument. An example of such an auto-calibration circuit is shown in FIG. 6. An auto-calibration circuit 120 includes an inner ring 152, an outer ring 154, and a plurality of electrical connections 160. It is contemplated that the inner ring or the outer ring may not be continuous. For example, the inner ring 152 is not continuous because it does not extend to form a complete circle. The outer ring 154, on the other hand, is continuous. The inner ring and the outer ring may both be continuous and in another embodiment the inner ring and the outer ring are not continuous. It is contemplated that the inner ring and outer ring may be shapes other than circular.

The plurality of electrical connections 160 includes a plurality of outer contact areas 188 (e.g., contact pads). The plurality of outer contact areas 188 is radially positioned around the circumference of the auto-calibration circuit 120. It is contemplated that the plurality of outer contact areas may be located in different positions that depicted in FIG. 6.

The plurality of electrical connections 160 is adapted to be utilized by the instrument to auto-calibrate. The positioning of the outer contact areas 188 permits the auto-calibration circuit 120 to be read by instruments or meters that are capable of contacting the plurality of outer contact areas 188. The information from the plurality of electrical connections 160 corresponds to the plurality of test sensors 22. According to one embodiment, substantially all of the plurality of outer contact areas 188 are initially electrically connected to the first common connection (e.g., inner ring 152) and the second common connection (e.g., outer ring 154). To program the auto-calibration circuit, substantially all of the outer contact areas 188 in this embodiment will only be connected to one of the inner or outer rings 152, 154.

FIG. 6 does not depict a specific pattern, but rather shows all of the potential connections of the plurality of outer contact areas to the first and second common connections. One example of a pattern of the auto-calibration circuit 120 is shown in FIG. 7. It is contemplated that other patterns of the auto-calibration circuit may be formed.

Typically, at least one of the outer contact areas 188 will always be electrically connected to the first common connection (e.g., inner ring 152) and the second common connection (e.g., outer ring 154). For example, as shown in FIGS. 6 and 7, outer contact area 188a is always electrically connected to the outer ring 154. By having the individual outer contact areas 188 only connected to the inner or outer ring 152, 154 assists in maintaining a reliable instrument since any “no connect” may be sensed by the instrument software. Thus, a defective auto-calibration circuit or bad connection from the instrument may be automatically sensed by the instrument software.

According to one method, the auto-calibration circuit (e.g., auto-calibration circuits 10, 120) to be used with at least one instrument may be formed by providing a substrate. It is contemplated, thus, that other auto-calibration circuits with different electrical connections besides those depicted in FIGS. 4-7 may be formed by the process of the present invention.

A catalytic ink or catalytic polymeric solution is applied to at least one side of the substrate. The catalytic ink or catalytic polymeric solution is used to assist in defining the electrical connections on the substrate. After the catalytic ink or catalytic polymeric solution is placed on the substrate, the substrate is electrolessly plated to form the electrical connections on the substrate. The electrical connections convey auto-calibration information for the test sensor to the instrument or meter. The electrical connections form a pattern that is adapted to be utilized by at least one instrument to auto-calibrate. For example; the auto-calibration circuit may be used with one instrument to auto-calibrate. In another embodiment, the auto-calibration circuit may be used with at least two instruments to auto-calibrate in which the first and second instruments are different.

The substrate to be used in forming the auto-calibration circuit may be comprised from a variety of materials. The substrate is typically made of insulated material. For example, the substrate may be formed from a polymeric material. Non-limiting examples of polymeric materials that may be used in forming the substrate include polyethylene, polypropylene, oriented polypropylene (OPP), cast polypropylene (CPP), polyethylene terephthlate (PET), polyether ether ketone (PEEK), polyether sulphone (PES), polycarbonate, or combinations thereof.

In one embodiment, a catalytic ink or catalytic polymeric solution adapted to be electrolessly plated is used. One example of a catalytic polymeric solution is an ink-jet printable catalytic polymer. The catalytic ink or catalytic polymeric solution adapted to be electrolessly plated may be applied to the substrate by a variety of methods such as screen printing, gravure printing, and ink-jet printing. The catalytic ink or catalytic polymeric solution includes a thermoset or thermoplastic polymer to allow the production of a catalytic film adhered to the substrate.

According to one method, after the catalytic ink or catalytic polymeric solution is applied, it is dried or cured. One example of a drying or curing process that may be used is curing by ultraviolet light. The drying process may include drying or curing by applying thermal heat. The catalytic ink or catalytic polymeric solution has catalytic properties to allow electroless plating. This film is now capable of being electrolessly plated.

After the catalytic ink or catalytic polymeric solution has been applied to the substrate and dried in the process, the substrate is electrolessly plated. Electroless plating uses a redox reaction to deposit conductive metal on the substrate without using an electric current. The conductive metal is generally placed on the predefined pattern of the resulting catalytic film that has been applied to the substrate. Thus, the conductive metal is deposited over the dried or cured catalytic film that includes the electroless plating catalyst.

Non-limiting examples of conductive metals that may be used in electroless plating include copper, nickel, gold, silver, platinum, palladium, rhodium, cobalt, tin, combinations or alloys thereof. For example, a palladium/nickel combination may be used as the conductive metal or a cobalt alloy may be used as the conductive metal. It is contemplated that other metallic materials and alloys of the same may be used in the electroless plating process. The thickness of the conductive metallic material may vary, but generally is from about 1 to about 100μ inches and, more typically, from about 5 to about 50μ inches.

The electroless plating process typically involves reducing a complex metal in an aqueous solution. The aqueous solution typically includes a mild or strong reducing agent that varies by the metal or the bath. One reducing agent that may be used in electroless plating is sodium hypophosphite (NaH₂PO₂). It is contemplated that other reducing agents may be used in electroless plating.

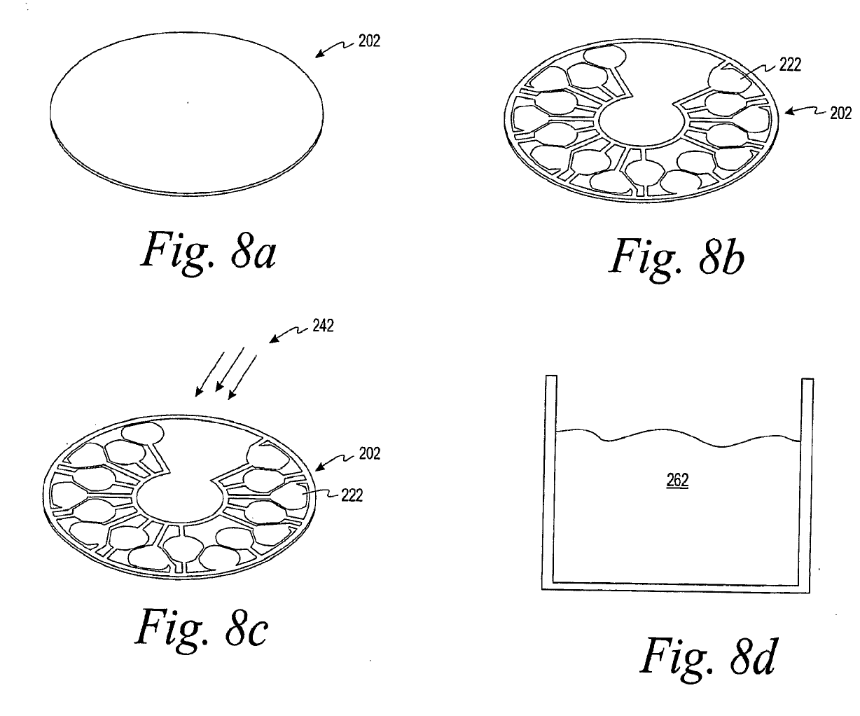

One non-limiting example of such a process is depicted in connection with FIGS. 8a-d. In FIG. 8a, a substrate 202 is provided that is generally circular shaped. It is contemplated that the substrate may be of other sizes and shapes. As shown in FIG. 8b, a catalytic ink or catalytic polymeric solution 222 is applied on the substrate 202. The substrate 202 with catalytic ink or catalytic polymeric solution 222 is then exposed to ultraviolet (UV) light 242 as shown in FIG. 8c. After being exposed to the UV light 242, the substrate 202 with dried or cured electroless catalyst film is then electrolessly plated. As shown in FIG. 8d, the electroless plating takes place in a bath 262. The substrate may be electrolessly plated by an autocatalytic or immersion plating process. The substrate 202 is removed and dried to form an auto-calibration circuit. In this particular example, the auto-calibration circuit is shown in FIG. 4.

According to another method, the auto-calibration circuit may form electrical connections on two opposing sides. In this method, a substrate is provided. The substrate includes at least one aperture formed therethrough. It is desirable for the substrate to form a plurality of apertures, which in one embodiment may be referred to as via apertures. The apertures may be circular shaped with a diameter generally from about 5 to about 30 mils.

The plurality of apertures may also be of different shapes than the generally circular shaped plurality of apertures such as polygonal shapes (e.g., square, rectangle) or non-polygonal shapes (e.g., oval). The plurality of apertures may be formed by a variety of methods including cutting or punching. One method of cutting to form the plurality of apertures 102a-d is by using a laser. By forming the apertures through the substrate, an electrical connection may be formed between the front side and the back side of the substrate.

The catalytic ink or catalytic polymeric solution is provided on two opposing sides of the substrate. The catalytic ink or catalytic polymeric solution is used to assist in defining the electrical connections on the substrate. After the catalytic ink or catalytic polymeric solution is placed on opposing sides of the substrate and then cured or dried, the substrate is electrolessly plated to form the electrical connections of the substrate. The electrical connections, which are on opposing sides of the substrate, convey auto-calibration information for the at least one test sensor to the instrument or meter.

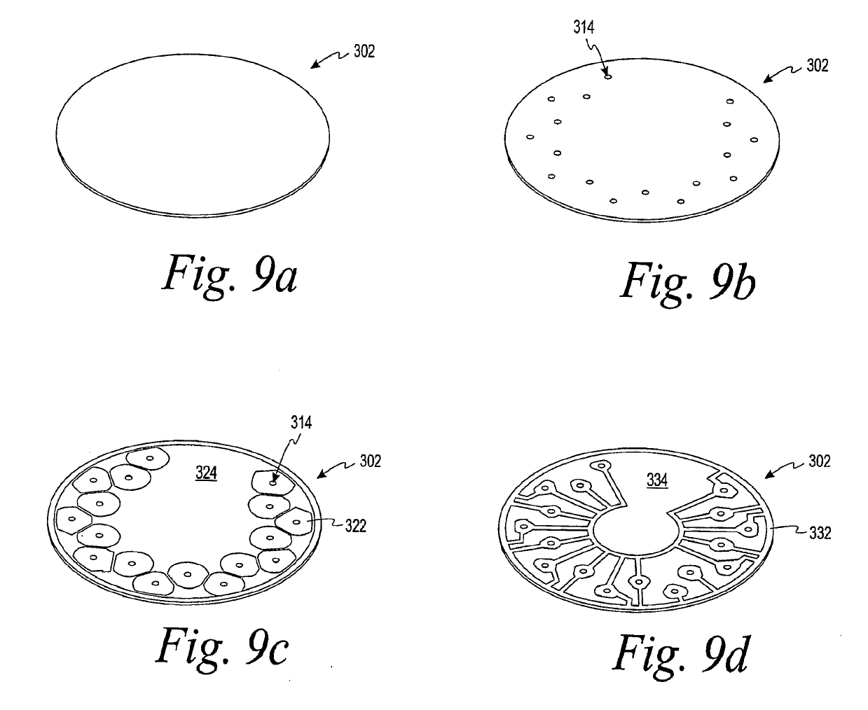

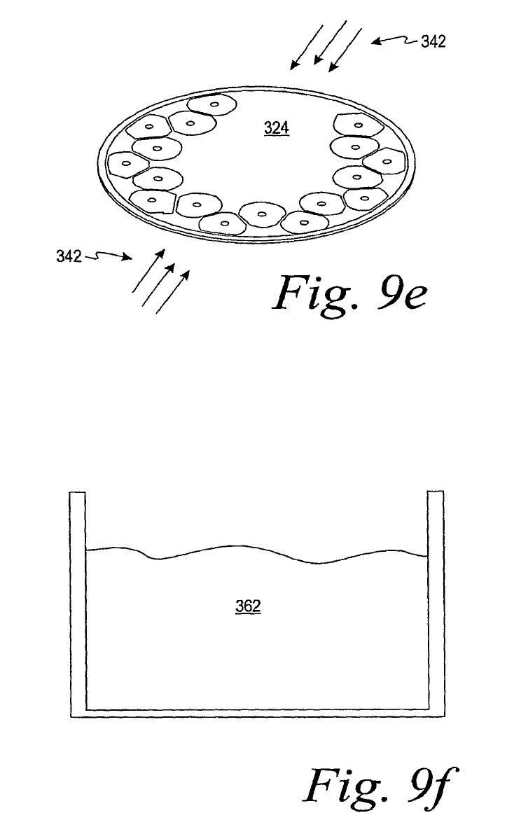

One non-limiting example of such a process is depicted in connection with FIGS. 9a-9f. In FIG. 9a, a substrate 302 is provided that is generally circular shaped. In FIG. 9b, a plurality of apertures 314 is formed through the substrate 302. The apertures 314 as discussed above may be formed by, for example, a laser. The number, shape and size of the plurality of apertures 314 may vary from that depicted in FIG. 9b.

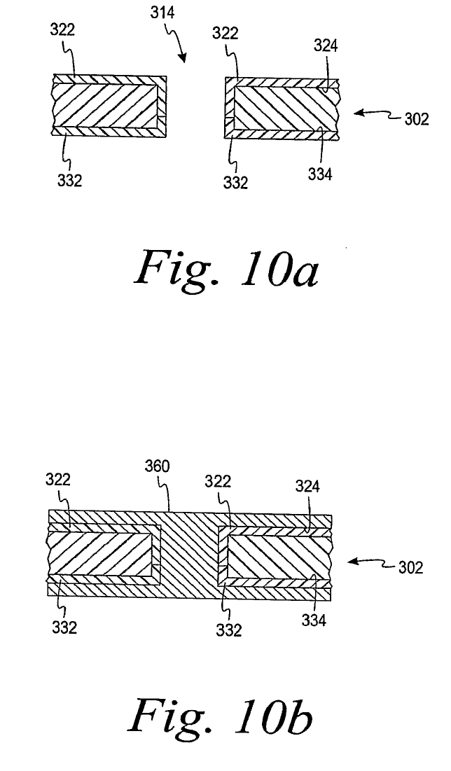

In FIG. 9c, catalytic ink or catalytic polymeric solution 322 is applied on a first side 324 of the substrate 302. In FIG. 9d, catalytic ink or catalytic polymeric solution 332 is applied on a second opposing side 334 of the substrate 302. An illustration of the catalytic ink or catalytic polymeric solution 322, 332 after being applied to a surface of one of the plurality of the apertures 314 is shown in FIG. 10a.

The substrate 302 with catalytic ink or catalytic polymeric solution 322, 332 is exposed to TV light 342 in FIG. 9e. After being exposed to the UV light 342 in FIG. 9e, the substrate is exposed to electroless plating. As shown in FIG. 9f, the electroless plating takes place in a bath 362, which contains an electroless plating solution. The substrate may be electrolessly plated by an autocatalytic or immersion plating process. The substrate 302 is removed from the bath 362 and is dried to form an auto-calibration circuit that has electrical connections on both sides that electrically communicate with each other via the plurality of apertures 314. Specifically, the conductive metal located in the plurality of apertures 314 establishes the electrical connection between the sides of the substrate 302. This is illustrated, for example, in FIG. 10b where a plating layer 360 is formed on the catalytic ink or catalytic polymeric solution 322, 332 and also extends into and substantially fills the aperture. The plating layer 360 needs to be in a sufficient quantity and properly located in the aperture so as to establish an electrical connection between the sides 324, 334 of the substrate 302.

The methods for forming the auto-calibration circuit are adapted to produce high resolution electrical connections on the auto-calibration circuit. Specifically, the method of the present invention allows for auto-calibration circuits with 50 mm or less lines and spaces between electrical connections. Additionally, in some embodiments, the auto-calibration circuit is adapted to utilize both sides of the substrate through the use of apertures to better define the auto-calibration features on the test sensor or on the packaging. By moving the electrical connections to the other side of the substrate, the pins of the instrument or meter are less likely to cut or bridge the traces between different pads.

The auto-calibration circuits (e.g., auto-calibration circuits 20, 120) of the present invention may be formed and then attached to a sensor package (e.g., sensor package 12). The auto-calibration circuit may be attached to the sensor package via, for example, an adhesive or other attachment method.

The auto-calibration circuits 20, 120 of FIGS. 4-7 are generally circular shaped. It is contemplated, however, that the auto-calibration circuits may be of different shapes than depicted in FIGS. 4-9. For example, the auto-calibration circuit may be a square, rectangle, other polygonal shapes, and non-polygonal shapes including oval. It is also contemplated that the contacts areas may be in different locations than depicted in FIGS. 4-9. For example, the contacts may be in a linear array.

It is contemplated that the auto-calibration circuits 20, 120 may be used with instruments other than instrument 10 depicted in FIGS. 1, 2. The auto-calibration circuits 20, 120 may also be used in other type of sensor packs than sensor package 12. For example, the auto-calibration circuits may be used in sensor packages such as a cartridge with a stacked plurality of test sensors or a drum-type sensor package.

### Process A

A method of forming an auto-calibration circuit to be used with a sensor package, the sensor package including at least one test sensor and is adapted to be used with an instrument or meter, the method comprising the acts of:

providing a substrate;

applying a catalytic ink or catalytic polymeric solution to at least one side of the substrate, the catalytic ink or catalytic polymeric solution being used to assist in defining electrical connections on the substrate; and

electrolessly plating of the substrate where the catalytic ink or catalytic polymeric solution was applied to form the electrical connections of the substrate, the electrical connections conveying auto-calibration information for the at least one test sensor to the instrument.

### Process B

The method of process A wherein the substrate is a polymeric material.

### Process C

The method of process B wherein the polymeric material includes polyethylene, polypropylene, oriented polypropylene (OPP), cast polypropylene (CPP), polyethylene terephthlate (PET), polyether ether ketone (PEEK), polyether sulphone (PES), polycarbonate, or combinations thereof.

### Process D

The method of process A wherein the electroless plating uses a conductive metal being copper, nickel, gold, silver, platinum, palladium, rhodium, cobalt, tin, combinations or alloys thereof.

### Process E

The method of process D wherein the thickness of the conductive metallic material is from about 1 to about 100μ inches.

### Process F

The method of process E wherein the thickness of the conductive metallic material is from 5 to about 50μ inches.

### Process G

The method of process A wherein the catalytic ink or catalytic polymeric solution is an inkjet printable catalytic polymer.

### Process H

The method of process A wherein the auto-calibration circuit is adapted to be used with exactly one type of instrument.

### Process I

The method of process A wherein the auto-calibration circuit is adapted to be used with a plurality of instruments.

### Process J

The method of process A wherein the catalytic ink or catalytic polymeric solution is applied onto the substrate by ink-jet printing.

### Process K

The method of process A wherein the applying of the catalytic ink or catalytic polymeric solution is applied onto the substrate by screen printing.

### Process L

The method of process A wherein the applying of the catalytic ink or catalytic polymeric solution is applied onto the substrate by gravure printing.

### Process M

The method of process A further including drying or curing the catalytic ink or catalytic polymeric solution.

### Process N

A method of forming an auto-calibration circuit to be used with a sensor package, the sensor package including at least one test sensor and is adapted to be used with an instrument or meter, the method comprising the acts of:

providing a substrate;

forming at least one aperture through the substrate;

applying a catalytic ink or catalytic polymeric solution to two opposing sides of the substrate, the catalytic ink or catalytic polymeric solution being used to assist in defining electrical connections on the substrate; and

electrolessly plating of the substrate where the catalytic ink or catalytic polymeric solution was applied to form the electrical connections of the substrate, the electrical connections conveying auto-calibration information for the at least one test sensor to the instrument.

### Process O

The method of process N wherein at least one aperture is formed by a laser prior to defining the electrical connections of the substrate.

### Process P

The method of process N wherein at least one aperture is formed by punching prior to defining the electrical connections of the substrate.

### Process Q

The method of process N wherein the at least one aperture is a plurality of apertures.

### Process R

The method of process N wherein the substrate is a polymeric material.

### Process S

The method of process R wherein the polymeric material includes polyethylene, polypropylene, oriented polypropylene (OPP), cast polypropylene (CPP), polyethylene terephthlate (PET), polyether ether ketone (PEEK), polyether sulphone (PES), polycarbonate, or combinations thereof.

### Process T

The method of process N wherein the electroless plating uses a conductive metal being copper, nickel, gold, silver, platinum, palladium, rhodium, cobalt, tin, combinations or alloys thereof.

### Process U

The method of process T wherein the thickness of the conductive metallic material is from about 1 to about 100μ inches.

### Process V

The method of process U wherein the thickness of the conductive metallic material is from 5 to about 50μ inches.

### Process W

The method of process N wherein the catalytic ink or catalytic polymeric solution is applied onto the substrate by ink-jet printing.

### Process X

The method of process N wherein the applying of the catalytic ink or catalytic polymeric solution is applied into the substrate by screen printing.

### Process Y

The method of process N wherein the applying of the catalytic ink or catalytic polymeric solution is applied into the substrate by gravure printing.

### Process Z

A method of forming a sensor package adapted to be used with at least one instrument in determining an analyte concentration in a fluid sample, the method comprising the acts of:

providing a substrate;

applying a catalytic ink or catalytic polymeric solution to at least one side of the substrate, the catalytic ink or catalytic polymeric solution being used to assist in defining the electrical connections on the substrate; and

electrolessly plating of the substrate where the catalytic ink or catalytic polymeric solution was applied to form the electrical connections of the substrate, the electrical connections conveying auto-calibration information for the at least one test sensor to the instrument;

attaching the auto-calibration circuit to a surface of a sensor-package base; and

providing at least one test sensor being adapted to receive the fluid sample and being operable with at least one instrument.

### Process AA

The method of process Z wherein the at least one test sensor is a plurality of sensors and further providing a pluralities of cavities containing a respective one of the pluralities of test sensors, the plurality of test cavities being arranged around the auto-calibration circuit.

### Process BB

The method of process Z wherein the substrate is a polymeric material.

### Process CC

The method of process BB wherein the polymeric material includes polyethylene, polypropylene, oriented polypropylene (OPP), cast polypropylene (CPP), polyethylene terephthlate (PET), polyether ether ketone (PEEK), polyether sulphone (PES), polycarbonate, or combinations thereof.

### Process DD

The method of process Z wherein the electroless plating uses a conductive metal being copper, nickel, gold, silver, platinum, palladium, rhodium, cobalt, tin, combinations or alloys thereof.

### Process EE

The method of process DD wherein the thickness of the conductive metallic material is from about 1 to about 100μ inches.

### Process FF

The method of process EE wherein the thickness of the conductive metallic material is from 5 to about 50μ inches.

### Process GG

The method of process Z wherein the catalytic ink or catalytic polymeric solution is an ink-jet printable catalytic polymer.

### Process HH

The method of process Z wherein the catalytic ink or catalytic polymeric solution is applied onto the substrate by ink-jet printing.

### Process II

The method of process Z wherein the applying of the catalytic ink or catalytic polymeric solution is applied onto the substrate by screen printing.

### Process JJ

The method of process Z wherein the applying of the catalytic ink or catalytic polymeric solution is applied onto the substrate by gravure printing.

### Process KK

The method of process Z further including drying or curing the electroless plating catalyst solution or ink.

While the present invention has been described with reference to one or more particular embodiments, those skilled in the art will recognize that many changes may be made thereto without departing from the spirit and scope of the present invention. Each of these embodiments, and obvious variations thereof, is contemplated as falling within the spirit and scope of the invention as defined by the appended claims.

1. A method of forming an auto-calibration circuit to be used with a sensor package, the sensor package including at least one test sensor and is adapted to be used with an instrument or meter, the method comprising the acts of:
providing a substrate;
applying a catalytic ink or catalytic polymeric solution to at least one side of the substrate, the catalytic ink or catalytic polymeric solution being used to assist in defining electrical connections on the substrate; and
electrolessly plating of the substrate where the catalytic ink or catalytic polymeric solution was applied to form the electrical connections of the substrate, the electrical connections conveying auto-calibration information for the at least one test sensor to the instrument.

2. (canceled)

3. (canceled)

4. The method of claim 1, wherein the electroless plating uses a conductive metal being copper, nickel, gold, silver, platinum, palladium, rhodium, cobalt, tin, combinations or alloys thereof.

5. The method of claim 4, wherein the thickness of the conductive metallic material is from about 1 to about 100μ inches.

6. The method of claim 5, wherein the thickness of the conductive metallic material is from 5 to about 50μ inches.

7. (canceled)

8. The method of claim 1, wherein the auto-calibration circuit is adapted to be used with exactly one type of instrument.

9. (canceled)

10. The method of claim 1, wherein the catalytic ink or catalytic polymeric solution is applied onto the substrate by ink-jet printing.

11. The method of claim 1, wherein the applying of the catalytic ink or catalytic polymeric solution is applied onto the substrate by screen printing.

12. (canceled)

13. (canceled)

14. A method of forming an auto-calibration circuit to be used with a sensor package, the sensor package including at least one test sensor and is adapted to be used with an instrument or meter, the method comprising the acts of:
providing a substrate;
forming at least one aperture through the substrate;
applying a catalytic ink or catalytic polymeric solution to two opposing sides of the substrate, the catalytic ink or catalytic polymeric solution being used to assist in defining electrical connections on the substrate; and
electrolessly plating of the substrate where the catalytic ink or catalytic polymeric solution was applied to form the electrical connections of the substrate, the electrical connections conveying auto-calibration information for the at least one test sensor to the instrument.

15. The method of claim 14, wherein at least one aperture is formed by a laser prior to defining the electrical connections of the substrate.

16. The method of claim 14, wherein at least one aperture is formed by punching prior to defining the electrical connections of the substrate.

17. (canceled)

18. (canceled)

19. (canceled)

20. The method of claim 14, wherein the electroless plating uses a conductive metal being copper, nickel, gold, silver, platinum, palladium, rhodium, cobalt, tin, combinations or alloys thereof.

21. The method of claim 20, wherein the thickness of the conductive metallic material is from about 1 to about 100μ inches.

22. The method of claim 21, wherein the thickness of the conductive metallic material is from 5 to about 50μ inches.

23. (canceled)

24. (canceled)

25. (canceled)

26. A method of forming a sensor package adapted to be used with at least one instrument in determining an analyte concentration in a fluid sample, the method comprising the acts of:
providing a substrate;
applying a catalytic ink or catalytic polymeric solution to at least one side of the substrate, the catalytic ink or catalytic polymeric solution being used to assist in defining the electrical connections on the substrate; and
electrolessly plating of the substrate where the catalytic ink or catalytic polymeric solution was applied to form the electrical connections of the substrate, the electrical connections conveying auto-calibration information for the at least one test sensor to the instrument;
attaching the auto-calibration circuit to a surface of a sensor-package base; and
providing at least one test sensor being adapted to receive the fluid sample and being operable with at least one instrument.

27. The method of claim 26, wherein the at least one test sensor is a plurality of sensors and further providing a pluralities of cavities containing a respective one of the pluralities of test sensors, the plurality of test cavities being arranged around the auto-calibration circuit.

28. The method of claim 26, wherein the substrate is a polymeric material.

29. (canceled)

30. The method of claim 26, wherein the electroless plating uses a conductive metal being copper, nickel, gold, silver, platinum, palladium, rhodium, cobalt, tin, combinations or alloys thereof.

31. The method of claim 30, wherein the thickness of the conductive metallic material is from about 1 to about 100μ inches.

32. The method of claim 31, wherein the thickness of the conductive metallic material is from 5 to about 50μ inches.

33. (canceled)

34. (canceled)

35. (canceled)

36. (canceled)

37. The method of claim 26 further including drying or curing the electroless plating catalyst solution or ink.
